(19) United States
(12) Patent Application Publication
(10) Pub. No.: US 2025/0194845 A1
(43) Pub. Date: Jun. 19, 2025

(54) POT LID ASSEMBLY AND PRESSURE COOKING APPLIANCE

(71) Applicant: FOSHAN SHUNDE MIDEA ELECTRICAL HEATING APPLIANCES MANUFACTURING CO., LTD., Foshan (CN)

(72) Inventors: Zhong YANG, Foshan (CN); Xianglong YANG, Foshan (CN)

(21) Appl. No.: 18/660,041

(22) Filed: May 9, 2024

(30) Foreign Application Priority Data
Dec. 14, 2023 (CN) 202323423765.X

(51) Int. Cl. A47J 27/09

(52) U.S. Cl. CPC A47J 27/09

(57) ABSTRACT

A pot lid assembly includes a lid body including a mounting hole, and a float member movably penetrating in the mounting hole and having a fitting end and a free end. The fitting end is configured to turn on or cut off an end of the mounting hole and the free end is arranged close to another end of the mounting hole. The float member has an extendible structure, such that a distance between the free end and the fitting end is adjustable. The pot lid assembly further includes a limit member disposed in the mounting hole. The fitting end and the free end are located on two sides, respectively, of the limit member along a flow direction of the mounting hole. The limit member is configured to limit the distance between the free end and the fitting end.

### CROSS-REFERENCE TO RELATED APPLICATION

This application claims priority to Chinese Application No. 202323423765.X, filed on Dec. 14, 2023, the entire content of which is incorporated herein by reference.

### TECHNICAL FIELD

The disclosure relates to the technical field of cooking apparatus, and in particular to a pot lid assembly and a pressure cooking appliance.

### BACKGROUND

In the related art, a pot lid of a pressure cooking appliance is usually equipped with a float. When a cooking cavity is pressurized, the float rises and protrudes from the pot lid to prompt a user of a state of pressure in the cooking cavity. However, in an actual application, there is a higher risk that the float protruding from the pot lid might be accidentally touched. If the float is pressed down by an external force, the cooking cavity is easily caused to release pressure, which not only affects a normal progress of a cooking process, but also easily leads to safety accidents such as a scalding of users, thereby limiting an improvement of user experience.

### SUMMARY

The disclosure aims to solve at least one of the technical problems existing in the related art or related technologies.

To this end, a first aspect of the disclosure provides a pot lid assembly.

A second aspect of the disclosure provides a pressure cooking appliance.

In view of this, the pot lid assembly is proposed according to a first aspect of embodiments of the disclosure, including: a lid body used to cover or open a pot mouth, and opened with a mounting hole; a float member movably penetrating in the mounting hole, and having a fitting end and a free end, the fitting end being used to turn on or cut off an end of the mounting hole, the free end being arranged close to another end of the mounting hole, the float member having an extendible structure, such that a distance between the free end and the fitting end is adjustable; and a limit member disposed in the mounting hole, in which the fitting end and the free end are respectively located on two sides of the limit member along a flow direction of the mounting hole, and in which the limit member is used to limit the distance between the free end and the fitting end.

In a feasible embodiment, a minimum distance between a side of the limit member facing toward the free end and the fitting end is a first distance; the float member is provided with a first positioning member, the first positioning member being used to abut against the side of the limit member facing toward the free end; and in a case that the float member is in an extreme compression state, a distance between the first positioning member and the fitting end is a second distance, the first distance being greater than the second distance.

In a feasible embodiment, the float member includes: a base seat disposed at the lid body and located at an end of the mounting hole, and opened with a fitting hole in communication with the mounting hole; a float body movably penetrating in the fitting hole; a seal member, sleeved on an end of the float body and used to cover or open the fitting hole; and an elastic extendible member connected to another end of the float body and movably penetrating in the mounting hole; in which, the fitting end is formed at the seal member, and the free end is located at an end of the elastic extendible member away from the float body.

In a feasible embodiment, two ends of the elastic extendible member are respectively located on two sides of the limit member along the flow direction of the mounting hole, the limit member being used to limit a distance between the two ends of the elastic extendible member.

In a feasible embodiment, the float member further includes: a float ejector rod connected to the elastic extendible member, and formed with the free end; and a first positioning member, disposed at the float ejector rod and used to abut against the side of the limit member facing toward the free end; in which, in a case that the first positioning member abuts against the side of the limit member facing toward the free end, a gap is formed between the float ejector rod and the float body.

In a feasible embodiment, the float member further includes: a second positioning member disposed at the float ejector rod and used to abut against a side of the limit member facing toward the fitting end, the elastic extendible member being located between the second positioning member and the float body; in which, along the flow direction of the mounting hole, a distance between the first positioning member and the second positioning member is greater than a distance between the two sides of the limit member.

In a feasible embodiment, an end of the float ejector rod close to the float body is penetrated in the elastic extendible member.

In a feasible embodiment, a stiffness coefficient of the elastic extendible member satisfies:

$$k \leq \frac{{p}_{min} \cdot A - {G}_{0} - {G}_{1} - {G}_{2}}{{x}_{max}}$$

in which, k is the stiffness coefficient of the elastic extendible member; pₘᵢₙ is a minimum working pressure of the pressure cooking appliance; A is an area of orthographic projection of the seal member in a projection plane perpendicular to the direction of gravity; G₀ is a gravity of the elastic extendible member; G₁ is a gravity of the float body; G₂ is a gravity of the seal member; xₘₐₓ is a maximum amount of expansion and retraction of the elastic extendible member.

In a feasible embodiment, the elastic extendible member is made of silicone; or the elastic extendible member is a spring or an elastic piece.

In a feasible embodiment, the pot lid assembly further includes: a handle member disposed at the lid body.

According to a second aspect of embodiments of the disclosure, a pressure cooking appliance is provided, including: a pot body assembly formed with a pot mouth; and the pot lid assembly as proposed in any one of the above first aspects, used to open or cover the pot mouth.

Compared with the related art, the disclosure at least includes the following beneficial effects: the pot lid assembly according to the embodiment of the disclosure includes a lid body, a float member and a limit member. In practical applications, the pot lid assembly according to the embodiments of the disclosure may be disposed at a pot body assembly of a pressure cooking appliance or used as a component of the pressure cooking appliance. In some embodiments, the lid body may be used to cover a pot mouth of the pot body assembly to enclose a cooking cavity with the pot body assembly; as shown in FIG. 2, during a pressure cooking process, a pressure in the cooking cavity can act on the float member, and the float member will move along the mounting hole of the lid body accordingly so that the fitting end of the float member contacts the lid body and cuts off an end of the mounting hole accordingly, and therefore the cooking cavity is prevented from being in communication with an external environment through the mounting hole to ensure a pressure in the cooking cavity to be stable, and the free end of the float member may protrude from another end of the mounting hole to prompt a user of a state of pressure in the cooking cavity. As shown in FIG. 3, in the above situation, if the free end of the float member is subjected to an external force and generates a tendency of movement of retracting into the mounting hole, then the float member can use, through a way of compression deformation, its own compression deformation to offset a displacement of the free end. At the same time, based on the arrangement of the limit member, a distance between the free end and the fitting end can also be avoided from being too small, and the free end and the fitting end can be prevented from contacting with each other due to the compression deformation, and therefore a position of the fitting end is prevented from being changed, and the mounting hole is prevented from being turned on during a pressure cooking process, and which is conducive to ensuring a stability of an internal pressure of the cooking cavity and at the same time reducing a probability of releasing of a high-temperature medium in the cooking cavity to the outside via the mounting hole, and in turn reducing a risk of scalding user, and therefore a safety of the pressure cooking process is improved, which is conducive to improving a user experience of a product.

### BRIEF DESCRIPTION OF DRAWINGS

Various other advantages and benefits will become apparent to those skilled in the art by reading the following detailed description of the exemplary embodiments. The accompanying drawings are for the purpose of illustrating exemplary embodiments only and are not to be considered as a limiting of the disclosure. Throughout the accompanying drawings, the same reference signs are used to designate the same components. In the accompanying drawings:

FIG. 1 is a schematic structural diagram of a pot lid assembly according to an embodiment of the disclosure;

FIG. 2 is a schematic enlarged view of a region indicated by A of the pot lid assembly shown in FIG. 1 in a first state;

FIG. 3 is a schematic enlarged view of the region indicated by A of the pot lid assembly shown in FIG. 1 in a second state;

FIG. 4 is a schematic enlarged view of the region indicated by A of the pot lid assembly shown in FIG. 1 in a third state; and

FIG. 5 is a schematic exploded structural diagram of a pressure cooking appliance according to an embodiment of the disclosure.

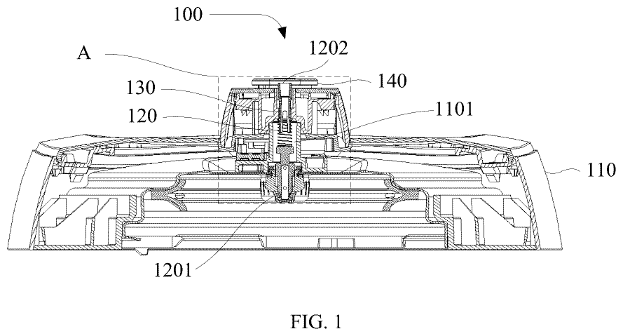

In the accompanying drawings, corresponding relationships between reference signs and component names in FIG. 1 to FIG. 5 are as follows:
100 pot lid assembly; 200 pot body assembly;
110 lid body; 120 float member; 130 limit member; 140 handle member; 150 seal part;
210 first pot body; 220 second pot body;
121 base seat; 122 float body; 123 seal member; 124 elastic extendible member; 125 float ejector rod; 126 first positioning member; 127 second positioning member;
1101 mounting hole;
1201 fitting end; 1202 free end.

### DESCRIPTION OF EMBODIMENTS

Exemplary embodiments of the disclosure will be described in more detail below with reference to the accompanying drawings. Although the exemplary embodiments of the disclosure are shown in the accompanying drawings, it should be understood that the disclosure may be implemented in various forms and should not be limited to the embodiments set forth herein. Rather, these embodiments are provided in order to provide a thorough understanding of the disclosure, and to fully convey the scope of the disclosure to those skilled in the art.

As shown in FIG. 1 to FIG. 5, a pot lid assembly 100 is proposed according to a first aspect of an embodiment of the disclosure, which may include: a lid body 110 for covering or opening a pot mouth, the lid body 110 being opened with a mounting hole 1101; a float member 120 movably penetrating in the mounting hole 1101 and having a fitting end 1201 and a free end 1202, the fitting end 1201 being used to turn on or cut off an end of the mounting hole 1101, the free end 1202 being arranged close to another end of the mounting hole 1101, the float member having an extendible structure such that a distance between the free end 1202 and the fitting end 1201 is adjustable; and a limit member 130 disposed in the mounting hole 1101, the fitting end 1201 and the free end 1202 being located respectively on two sides of the limit member 130 along a flow direction of the mounting hole 1101, the limit member 130 being used to limit the distance between the free end 1202 and the fitting end 1201.

The pot lid assembly 100 according to some embodiments of the disclosure includes the lid body 110, the float member 120 and the limit member 130. In some embodiments, the lid body 110 is opened with the mounting hole 1101, and the mounting hole 1101 can provide a space for mounting the float member 120 and the limit member 130. Correspondingly, the float member 120 is movably penetrated in the mounting hole 1101 and has an extendible structure, so that the float member 120 on the one hand can adjust positions of the fitting end 1201 and the free end 1202 by moving along a flow direction of the mounting hole 1101, and on the other hand can adjust a distance between the free end 1202 and the fitting end 1201 by a way of expansion and retraction deformation, and in turn can have a higher flexibility of movement, which facilitates adjustments of the positions of the fitting end 1201 and the free end 1202 during use. The fitting end 1201 is used to turn on or cut off an end of the mounting hole 1101, that is, the fitting end 1201 can abut against the lid body 110 and block the end of the mounting hole 1101, thereby cutting off the mounting hole 1101, or the fitting end 1201 can be separated from the lid body 110 and open an end of the mounting hole 1101, thereby turning on the mounting hole 1101. The free end 1202 is arranged close to another end of the mounting hole 1101 and can be configured to protrude from or retract into another other end of the mounting hole 1101. The limit member 130 is disposed within the mounting hole 1101, and the fitting end 1201 and the free end 1202 are respectively located on two sides of the limit member 130 along the flow direction of the mounting hole 1101, so that the distance between the free end 1202 and the fitting end 1201 of the float member 120 can be limited based on an arrangement of the limit member 130, thereby preventing a contact between the free end 1202 and the fitting end 1201.

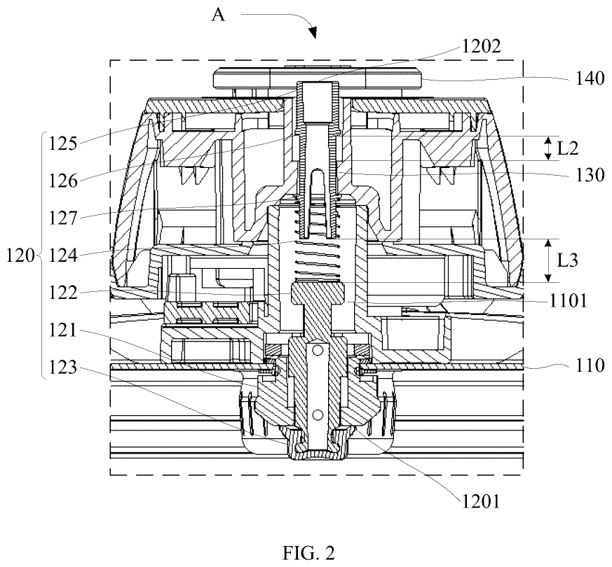

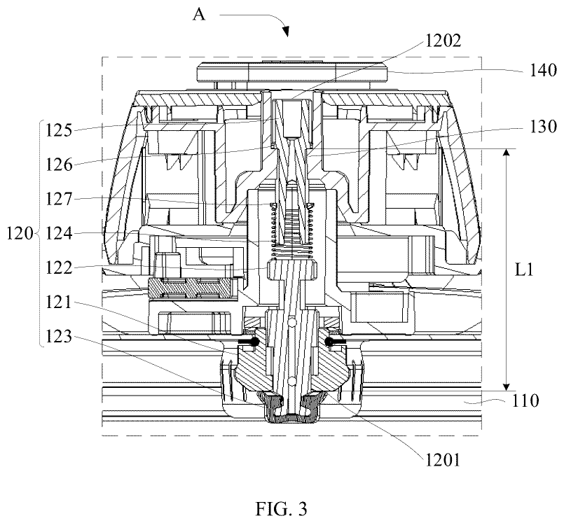

In practical applications, the pot lid assembly 100 according to some embodiments of the disclosure may be provided on a pot body assembly 200 of a pressure cooking appliance or used as a component of the pressure cooking appliance. In some embodiments, the lid body 110 may be used to cover a pot mouth of the pot body assembly 200 to enclose a cooking cavity with the pot body assembly 200. As shown in FIG. 2, during a pressure cooking process, a pressure in the cooking cavity can act on the float member 120, and the float member 120 will move along the mounting hole 1101 of the lid body 110 accordingly so that the fitting end 1201 of the float member 120 contacts the lid body 110 and accordingly cuts off an end of the mounting hole 1101, and therefore the cooking cavity is prevented from being in communication with an external environment via the mounting hole 1101 to ensure the pressure in the cooking cavity to be stable. The free end 1202 of the float member 120 may protrude from another end of the mounting hole 1101 to prompt a user of a state of pressure in the cooking cavity. As shown in FIG. 3, in the above situation, if the free end 1202 of the float member 120 is subjected to an external force and generates a tendency of movement of retracting into the mounting hole 1101, the float member 120 can use, through a way of compression deformation, its own compression deformation to offset a displacement of the free end 1202. At the same time, based on an arrangement of the limit member 130, a too small distance between the free end 1202 and the fitting end 1201 can also be avoided, and thus the free end 1202 and the fitting end 1201 can be prevented from contacting with each other due to the compression deformation, thereby preventing a position of the fitting end 1201 from being changed, avoiding the mounting hole 1101 from being turned on during a pressure cooking process, being conducive to reducing a probability of a high-temperature medium in the cooking cavity released to the outside via the mounting hole 1101 while a stability of an internal pressure of the cooking cavity is ensured, and in turn reducing a risk of scalding users, and therefore improving a safety of the pressure cooking process. Therefore it is conducive to improving a user experience for a product.

It can be understood that the high-temperature medium may be, but is not limited to, a high-temperature gas, a steam, a high-temperature liquid and so on.

It should be noted that in the traditional technology, a float of a pressure cooking appliance usually has a rigid structure. Therefore, in a case that a cooking cavity is pressurized and an end of the float is forced to cut off the mounting hole, if an end of the float protruding from the cooking cavity is subjected to an external force and generates a tendency of movement of retracting into the mounting hole, the float as a whole will be caused to move along the mounting hole to make the mounting hole to switch from a cut-off state to a turned-on state, thereby causing a pressure relief of the cooking cavity and a releasing of the high-temperature medium into the external environment via the mounting hole. If the external force is applied manually by a user, it is extremely easy to scald the user and a safety in the pressure cooking process is affected. Compared with the traditional technology, the pot lid assembly 100 according to the embodiments of the disclosure, based on the above arrangement, can utilize expansion and retraction deformation abilities of the float member 120 to offset the displacement of the free end 1202 and prevent the free end 1202 and the fitting end 1201 from contacting with each other due to compression deformation, thereby preventing the mounting hole 1101 from being turned on due to a change in a position of the fitting end 1201, being conducive to reducing the probability of the high-temperature medium in the cooking cavity released to the outside via the mounting hole 1101 while a stability of an internal pressure of the cooking cavity is ensured, and in turn reducing the risk of scalding user, and therefore improving the safety of the pressure cooking process, and therefore it is conducive to improving the user experience for the product.

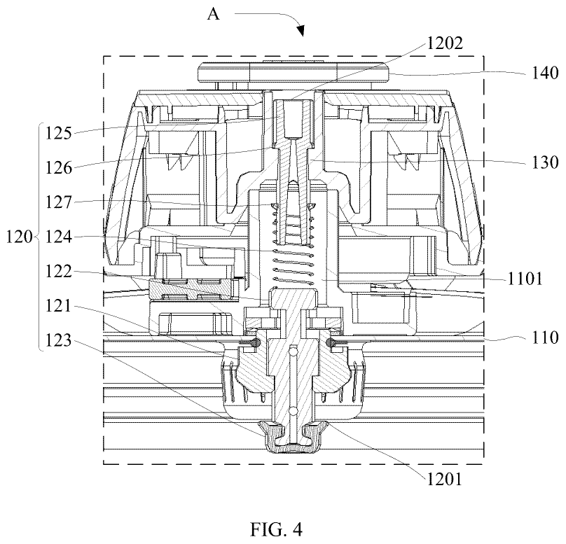

It can be understood that, as shown in FIG. 2 to FIG. 4, the pot lid assembly 100 according to the embodiments of the disclosure is based on the above arrangement, and the float member 120 may have, but be not limited to, a first working state, a second working state, and a third working state. In some embodiments, as shown in FIG. 2, in a case that the float member 120 is in the first working state, the fitting end 1201 abuts against the lid body 110 to cut off an end of the mounting hole 1101, and the free end 1202 protrudes from another end of the mounting hole 1101. As shown in FIG. 3, in a case that the float member 120 is in the second working state, the fitting end 1201 abuts against the lid body 110 to cut off the end of the mounting hole 1101, and the free end 1202 retracts into the another end of the mounting hole 1101. As shown in FIG. 4, in a case that the float member 120 is in the third working state, the fitting end 1201 is separated from the lid body 110 to turn on the mounting hole 1101, and the free end 1202 retracts into the another end of the mounting hole 1101. The various working states can be switched from one another by adjusting the position of the float member 120 along the flow direction of the mounting hole 1101 or stress conditions of two ends of the float member 120.

As shown in FIG. 1 to FIG. 5, the pot lid assembly 100 according to the embodiments of the disclosure applied to a pressure cooking appliance is taken as an example, and the mounting hole 1101 may be opened along a thickness direction of the lid body 110, so that in a case that the lid body 110 covers on the pot mouth, the flow direction of the mounting hole 1101 and an extending direction of the float member 120 both can maintain a high consistency with the direction of gravity. In some embodiments, the free end 1202 may be arranged close to an outer end of the mounting hole 1101, and the fitting end 1201 may be arranged close to an inner end of the mounting hole 1101. It can be understood that the outer end of the mounting hole 1101 is an end of the mounting hole 1101 away from the cooking cavity in a case that the lid body 110 covers the pot mouth, and the inner end of the mounting hole 1101 is an end of the mounting hole 1101 close to the cooking cavity in a case that the lid body 110 covers the pot mouth. Therefore, based on the above arrangement, the float member 120 can have displacements of rising and falling under a pressure difference between the cooking cavity and the external environment, which in turn facilitates the fitting end 1201 to perform a control of turning on-cutting off of the inner end of the mounting hole 1101, and facilitates the free end 1202 to protrude from or retract into the outer end of the mounting hole 1101 to reflect a pressure condition in the cooking cavity. Correspondingly, during the pressure cooking process, the float member 120 may be in the third working state before the pressure in the cooking cavity is pressurized. In a case that the pressure in the cooking cavity rises to a level of pressure under which ssthe float member 120 can be caused to overcome a resistance and generate an upward movement, the float member 120 can switch from the third working state to the first working state, and can use the free end 1202 to prompt the user about a status of the pressure in the cooking cavity. In a case that the float member 120 is in the first working state, such as the free end 1202 is subjected to an external force and generates a tendency of movement of retracting into the outer end of the mounting hole 1101, the float member 120 can use, through a way of compression deformation, its own compression deformation to offset the displacement of the free end 1202, and switch from the first working state to the second working state, thereby preventing the position of the fitting end 1201 from being changed and avoiding the mounting hole 1101 from being turned on in a case that a pressure in the cooking cavity is high. It can be understood that the float member 120 may be of an elastic extendible structure or

a non-elastic extendible structure. In some embodiments, in a case that the float member 120 is of the elastic extendible structure, the float member 120 may have good deformation and recovery capability, thereby being conducive to improving a performance of convenience of switching among working states of the float member 120, and facilitating a reuse of the float member 120. For example, in a case that the float member 120 is in the second working state, if the external force endured by the free end 1202 is removed, the float member 120 can return to the first working state. In a case that the float member 120 is of the non-elastic extendible structure, for example, in a case that the float member 120 may be of a flexible extendible structure or a non-elastic mechanical extendible mechanism such as an extendible rod, the float member 120 can have a lower resistance of expansion and retraction deformation, which is conducive to further reducing a force endured by the fitting end 1201 during a process of protruding and retracting, thereby further ensuring a positional stability of the fitting end 1201 during the float member 120 switches from the first working state to the second working state.

As shown in FIG. 1 to FIG. 4, in some feasible examples, the limit member 130 and the lid body 110 are of an integrated structure, thereby improving a connection strength between the limit member 130 and the lid body 110.

As shown in FIG. 3, in some examples, a minimum distance between a side of the limit member 130 facing toward the free end 1202 and the fitting end 1201 is a first distance L1. The float member 120 is provided with a first positioning member 126. The first positioning member 126 is used to abut against the side of the limit member 130 facing toward the free end 1202. In a case that the float member 120 is in an extreme compression state, a distance between the first positioning member 126 and the fitting end 1201 is a second distance. The first distance L1 is greater than the second distance.

In some technical solutions, the float member 120 may be provided with a first positioning member 126, and the first distance L1 may be set to be greater than the second distance. It can be understood that during use, the float member 120 can generate a displacement or an extendible amount along the flow direction of the mounting hole 1101. During a process of moving or expansion and retraction, the fitting end 1201 may approach to or be away from the lid body 110 and the limit member 130. As shown in FIG. 2 and FIG. 3, the fitting end 1201, in a case abutting against the lid body 110 and cutting off an end of the mounting hole 1101, is in a position closest to the limit member 130, and correspondingly, in a case that the fitting end 1201 is in the position, the distance between the side of the limit member 130 facing toward the free end 1202 and the fitting end 1201 is the first distance. At the same time, since the float member 120 is of the extendible structure, the float member 120 will have a corresponding extendible limit, and the extreme compression state refers to a state in which a length of the float member 120 in an extendible direction is the smallest in a case that the float member 120 is not limited by an amount of compression externally applied and does not have a failure phenomenon.

Therefore, based on the arrangement of this technical solution, on one aspect, the float member 120 can use the first positioning member 126 during a movement to cooperate with the limit member 130 to restrict a movement stroke of the free end 1202, and in turn limit the distance between the fitting end 1201 and the free end 1202, thereby avoiding a contact between the fitting end 1201 and the free end 1202, and reducing a risk of a displacement of the fitting end 1201 in a case that the pressure in the cooking cavity is high. On another aspect, based on a relationship of size between the first distance L1 and the second distance, an extendible range of the float member 120 in practical applications can be further constrained and restricted. During use, the float member 120 can be avoided from reaching the extreme compression state, and the float member 120 can maintain a certain margin in a compression performance, and therefore a stiffness of the float member 120 during use is reduced, and in turn if the free end 1202 is subjected to the external force and generates a tendency of movement of retracting into the mounting hole 1101, the float member 120 can more reliably use its own compression deformation to offset the displacement of the free end 1202 and weaken an influence of the external force on the fitting end 1201, and therefore a further reliable guarantee is provided for stabilizing the position of the fitting end 1201 during the pressure cooking process. On a further aspect, in a case that the pressure in the cooking cavity is high, such as in a case that the free end 1202 is subjected to the external force and generates a displacement of retracting into the mounting hole 1101, the first positioning member 126 can abut against the limit member 130 when an amount of the displacement reaches a certain degree, and in turn a supporting function of the limit member 130 can be used to offset the external force. Thus the external force is further prevented from being transmitted to the fitting end 1201 through the structure of the float member 120, which is conducive to further ensuring a cutting-off effect of the fitting end 1201 on the mounting hole 1101, reducing the risk that the mounting hole 1101 is turned on during the pressure cooking process. Therefore, the safety of the pressure cooking process is improved.

As shown in FIG. 2 to FIG. 5, in some examples, the float member 120 includes: a base seat 121, which is disposed at the lid body 110 and located at an end of the mounting hole 1101, and is opened with a fitting hole which is in communication with the mounting hole 1101; a float body 122, movably penetrating in the fitting hole; a seal member 123, which is sleeved on an end of the float body 122 and used to cover or open the fitting hole; and an elastic extendible member 124, which is connected to another end of the float body 122, and movably penetrates in the mounting hole 1101. In some embodiments, the fitting end 1201 is formed at the seal member 123, and the free end 1202 is located at an end of the elastic extendible member 124 away from the float body 122.

In some technical solutions, the float member 120 may include a base seat 121, a float body 122, a seal member 123 and an elastic extendible member 124. In some embodiments the base seat 121 is disposed at the lid body 110 and is located at an end of the mounting hole 1101, and the base seat 121 is opened with a fitting hole being in communication with the mounting hole 1101, so that the base seat 121 can partially cover a corresponding end of the mounting hole 1101. The float body 122 is penetrated in the fitting hole and can move relative to the fitting hole, so that the float body 122 can generate, through a way of moving relative to the fitting hole, a displacement along the flow direction of the mounting hole 1101. The seal member 123 is sleeved on an end of the float body 122 and has the fitting end 1201, so that the seal member 123 can moves synchronously with an movement of the float body 122 and cover or open the fitting hole, and in turn a control of turning on-cutting off state of an end of the mounting hole 1101 is realized by switching opening and closing states of the fitting hole, and a leakproofness of the fitting hole can be guaranteed in a case that the fitting hole is covered. A risk of leakage of the high-temperature media in the cooking cavity is further reduced and a more reliable guarantee is provided for a pressure stability of the cooking cavity.

The elastic extendible member 124 is connected to an end of the float body 122 away from the seal member 123, and is movably penetrated into the mounting hole 1101. The free end 1202 is located at the end of the elastic extendible member 124 away from the float body 122, so that in practical applications, the float member 120 can achieve an expansion and retraction deformation based on the arrangement of the elastic extendible component 124, and in turn when the free end 1202 is subjected to the external force and generates the tendency of movement of retracting into the mounting hole 1101, the float member 120 can offset a displacement of the free end 1202 by a way of compression deformation to prevent a synchronous movement of the fitting end 1201. At the same time, the elastic extendible member 124 can store an energy during a compression process to absorb the external force, thus it is conducive to further reducing the force endured by the fitting end 1201 and a reliable guarantee is provided for stabilizing the position of the fitting end 1201. The elastic extendible member 124 can release the energy and resume the deformation after the external force is removed, so that the free end 1202 can protrude from the mounting hole 1101, thereby facilitating prompting the user of the state of pressure in the cooking cavity during the pressure cooking process, and thus it is beneficial to improving the user experience of the product.

It can be understood that the free end 1202 is located at an end of the elastic extendible member 124 away from the float body 122, in other words, the end of the elastic extendible member 124 away from the float body 122 is the free end 1202, or the end of the elastic extendible member 124 away from the float body 122 may be provided with another component having the float member 120, the free end 1202 being formed at the another components.

In some examples, along the flow direction of the mounting hole 1101, two ends of the elastic extendible member 124 are respectively located on two sides of the limit member 130. The limit member 130 is used to limit a distance between the two ends of the elastic extendible member 124.

In some technical solutions, along the flow direction of the mounting hole 1101, the two ends of the elastic extendible member 124 are respectively located on the two sides of the limit member 130, and an end of the elastic extendible member 124 away from the float body 122 is the free end 1202. Correspondingly, the limit member 130 can limit the distance between the free end 1202 and the fitting end 1201 by limiting the distance between the two ends of the elastic extendible member 124, so that based on the above arrangement, a length of the elastic extendible member 124 along the flow direction of the mounting hole 1101 can be increased, and therefore a proportion of the length of the elastic extendible member 124 in the extending direction of the float member 120 can be increased, thereby improving an extendible performance of the float member 120. It is conducive to further reducing a structural rigidity of the float member 120, and further improving, in practical applications, abilities of the float member 120 to offset the displacement of the free end 1202 and absorb external forces, and therefore a further guarantee is provided for stabilizing the position of the fitting end 1201.

It can be understood that in some technical solutions, the first positioning member 126 may be provided on the elastic extendible member 124.

As shown in FIG. 2 to FIG. 4, in some examples, the float member 120 further includes: a float ejector rod 125, which is connected to the elastic extendible member 124, and is formed with a free end 1202; and a first positioning member 126, which is disposed at the float ejector rod 125, and is used to abut against the side of the limit member 130 facing toward the free end 1202. In some embodiments, in a case that the first positioning member 126 abuts against the side of the limit member 130 facing toward the free end 1202, a gap is formed between the float ejector rod 125 and the float body 122.

In some technical solutions, the float member 120 may also include the float ejector rod 125 and the first positioning member 126. In some embodiments the float ejector rod 125 is connected to the elastic extendible member 124 and is formed with the free end 1202. The first positioning member 126 is disposed at the float ejector rod 125. It can be understood that the float ejector rod 125 may have, compared with the elastic extendible member 124, a rigid structure, that is, an elasticity of the float ejector rod 125 is smaller and lower than the elastic extendible member 124, and therefore the float ejector rod 125 is not easily deformed under an action of the external force and has good structural stability and reliability, and in turn in practical applications, a probability of structural damage of the float member 120 can be reduced and a service life of the float member 120 can be extended. The float ejector rod 125 can provide a good support condition for the first positioning member 126, which is conducive to maintaining a stable posture of the first positioning member 126, thereby ensuring a reliable cooperation between the first positioning member 126 and the limit member 130. At the same time, in a case that the first positioning member 126 abuts against the side of the limit member 130 facing toward the free end 1202, the gap may be formed between the float ejector rod 125 and the float body 122, so that in a case that the distance between the free end 1202 and the fitting end 1201 is small, a rigid contact between the float ejector 125 and the float body 122 can be avoided, which is conducive to further ensuring the positional stability of the fitting end 1201 during the pressure cooking process, thereby increasing the pressure in the cooking cavity. In a case that the pressure in the cooking cavity is high, the mounting hole 1101 can be further prevented from being turned on, which is beneficial to ensuring safety and stability of the pressure cooking process.

In some feasible examples, the first positioning member 126 and the float ejector rod 125 may be of an integrated structure, thereby improving a connection strength between the first positioning member 126 and the float ejector rod 125.

As shown in FIG. 2 to FIG. 4, in some examples, the float member 120 further includes: a second positioning member 127, which is disposed at the float ejector rod 125, and is used to abut against a side of the limit member 130 facing toward the fitting end 1201. The elastic extendible member 124 is located between the second positioning member 127 and the float body 122. In some embodiments, along the flow direction of the mounting hole 1101, a distance between the first positioning member 126 and the second positioning member 127 is greater than a distance between two sides of the limit member 130.

In some technical solutions, the float member 120 may also include a second positioning member 127 disposed at the float ejector rod 125. Along the flow direction of the mounting hole 1101, the first positioning member 126 and the second positioning member 127 are respectively located at the two sides of the limit member 130, and the second positioning member 127 is used to abut against the side of the limit member 130 facing toward the fitting end 1201. Correspondingly, the elastic extendible member 124 may be disposed between the second positioning member 127 and the float body 122, and the distance between the first positioning member 126 and the second positioning member 127 is set to be greater than the distance between the two sides of the limit member 130. Therefore, based on the above arrangement, on the one hand, the float member 120 can further utilize a fitting relationship between the second positioning member 127 and the limit member 130 to constrain a maximum distance between the free end 1202 and the fitting end 1201, and in turn an excessive protrusion amount of the float ejector rod 125 can be avoided during use, which is conductive to further reducing a probability of the float ejector rod 125 being accidentally touched. On the other hand, the second positioning member 127 can cooperate with the float body 122 to further constrain and restrict the extendible range of the elastic extendible member 124 during use, which is beneficial to improving the stability and reliability of the elastic extendible member 124 during a process of protruding and retracting and reducing a probability of the elastic extendible member 124 getting stuck during the process of protruding and retracting, and therefore a more reliable guarantee is provided for a functioning of an extendible performance of the float member 120.

As shown in FIG. 2, it can be understood that by a way of setting the distance between the first positioning member 126 and the second positioning member 127 along the flow direction of the mounting hole 1101 to be greater than the distance between two sides of the limit member 130, the float ejector rod 125 can be allowed to have a moving range as shown by a dimension line L2 in the flow direction of the mounting hole 1101, thereby ensuring a mobility of the free end 1202 and an extendible capability of the float member 120. Correspondingly, in order to ensure that the gap is formed between the float ejector rod 125 and the float body 122 in a case that the first positioning member 126 abuts against the side of the limit member 130 facing toward the free end 1202, a distance L3 between an end of the float ejector rod 125 close to the float body 122 and the float body 122 can, in a case that the float member 120 is in the first working state, be set to be greater than the moving range L2.

In some feasible examples, the second positioning member 127 and the float ejector rod 125 may be of an integrated structure, thereby improving a connection strength between the second positioning member 127 and the float ejector rod 125.

As shown in FIG. 2 to FIG. 4, in some examples, an end of the float ejector rod 125 close to the float body 122 is penetrated in the elastic extendible member 124.

In some technical solutions, an end of the float ejector rod 125 close to the float body 122 may be penetrated in the elastic extendible member 124, so that based on the above arrangement, a portion of the float ejector rod 125 penetrating in the elastic extendible member 124 can further constrain a posture of the elastic extendible member 124 during a process of expansion and retraction deformation, and can further reduce the probability of the elastic extendible member 124 getting stuck during use, which is conducive to providing further guarantee for smooth and stable processes of protruding and retracting of the float member 120.

In some examples, a stiffness coefficient of the elastic extendible member 124 satisfies:

$$k \leq \frac{{p}_{min} \cdot A - {G}_{0} - {G}_{1} - {G}_{2}}{{x}_{max}} \qquad ( 1 )$$

In the above formula (1), k is a stiffness coefficient of the elastic extendible member 124; pₘᵢₙ is a minimum working pressure of the pressure cooking appliance; A is an area of orthographic projection of the seal member 123 on a projection plane perpendicular to the direction of gravity; G₀ is a gravity of the elastic extendible member 124; G₁ is a gravity of the float body 122; G₂ is a gravity of the seal member 123; and xₘₐₓ is a maximum amount of expansion and retraction of the elastic extendible member 124.

In some technical solutions, in a case that the pot lid assembly 100 is applied to the pressure cooking appliance, the stiffness coefficient of the elastic extendible member 124 may be set to satisfy the above formula (1), and therefore a too large stiffness coefficient of the elastic extendible member 124 is avoided, which is beneficial to preventing the elastic extendible member 124 from generating an excessive elastic force when compressed, and in turn an elastic force exerted by the elastic extendible member 124 on the float body 122 can be reduced. Thus the float body 122 and the seal member 123 are prevented from overcoming a pressure in the cooking cavity to displace under an action of the elastic force, which is beneficial to ensuring a cutting-off effect of the fitting end 1201 on the mounting hole 1101, and a stability of the pressure in the cooking cavity is further ensured, and a risk of overflowing of the high-temperature medium in the cooking cavity is reduced.

It can be understood that the pressure cooking appliance usually has a rated working pressure range, and the minimum working pressure is also a minimum pressure of the cooking cavity of the pressure cooking appliance when a pressure cooking is performed. In combination with the description, in a case that the pot lid assembly 100 is applied to the pressure cooking appliance, the mounting hole 1101 can be opened along the thickness direction of the lid body 110, so that when the lid body 110 and the pot body assembly 200 enclose the cooking cavity, the extending direction of the float member 120 can have a high consistency with the direction of gravity. Therefore, based on a way of arrangement of the seal member 123, a product of the pressure in the cooking cavity with the area of orthographic projection A of the seal member 123 on the projection plane perpendicular to the direction of gravity can characterize an acting force exerted by an air pressure in the cooking cavity on the float member 120 in the direction of gravity.

As shown in FIG. 2 to FIG. 4, in some examples, the elastic extendible member 124 is made of silicone; or the elastic extendible member 124 is a spring or an elastic piece.

In some technical solutions, the elastic extendible member 124 may be made of silicone, so that the elastic extendible member 124 can have a good deformation ability of expansion and retraction and at the same time have a good moldability, which is beneficial to configuring a structural shape of the elastic extendible member 124 according to actual needs during the production of the lid assembly, thereby facilitating a formation of a stable and reliable fitting relationship between the elastic extendible member 124 and the mounting hole 1101, and improving the stability of the float member 120 during a process of protruding and retracting.

In other embodiments, the elastic extendible member 124 may be a spring, so that the elastic extendible member 124 can have the good deformation ability of expansion and retraction and at the same time have a good replaceability, which is beneficial to reducing costs of using, repairing and maintenance of the pot lid assembly 100.

In further embodiments, the elastic extendible member 124 may be an elastic piece, so that the elastic extendible member 124 can have the good deformation ability of expansion and retraction and at the same time have a good replaceability, which is beneficial to reducing costs of using, repairing and maintenance of the pot lid assembly 100.

As shown in FIG. 1 to FIG. 5, in some examples, the pot lid assembly 100 further includes: a handle member 140 disposed at the lid body 110.

In some technical solutions, the pot lid assembly 100 may also include a handle member 140 disposed at the lid body 110, so that it can facilitate a user to operate the pot lid assembly in practical applications, and it is conducive to further improving a convenience of use of the pot lid assembly 100.

It can be understood that the fitting ends of the handle member 140 and the float member 120 may be located on two sides of the lid body 110, respectively.

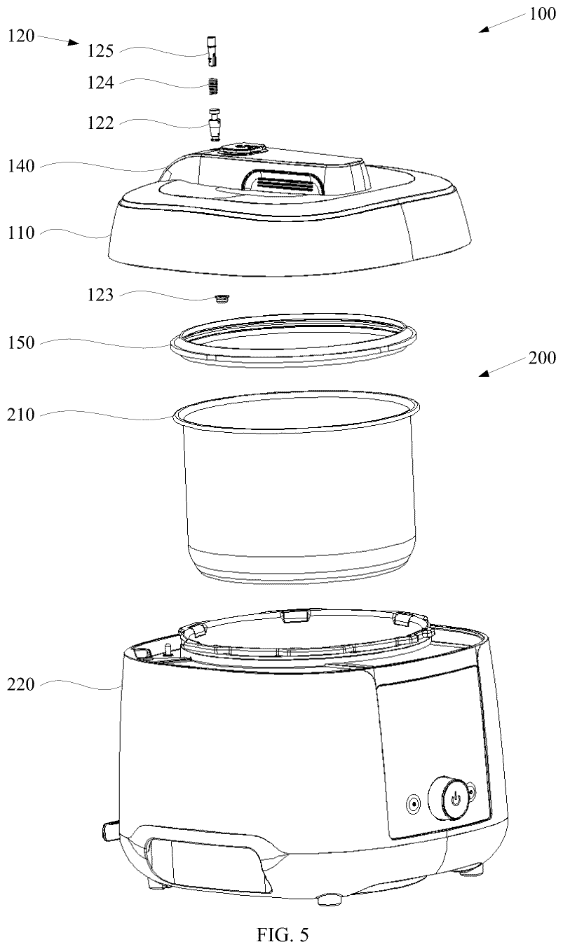

As shown in FIG. 5, in some feasible examples, the pot lid assembly 100 may also include a seal part 150 disposed at the lid body 110. In a case that the lid body 110 covers the pot mouth, the seal part 150 is located between the pot body assembly 200 and the lid body 110, and therefore the pot lid assembly 100 can further use the seal part 150 to block a gap between the lid body 110 and the pot mouth for providing further reliable guarantee for smooth and stable processes of the pressure cooking.

As shown in FIG. 5, a pressure cooking appliance is proposed according to a second aspect of embodiments of the disclosure, which includes: a pot body assembly 200 formed with a pot mouth; and a pot lid assembly 100, as proposed in any one of the first aspects, used to open or cover the pot mouth.

The pressure cooking appliance according to some embodiments of the disclosure includes a pot body assembly 200 and a pot lid assembly 100 as proposed in any one of the first aspects. The lid body 110 may be used to cover a pot mouth of the pot body assembly 200 to enclose a cooking cavity with the pot body assembly 200. As shown in FIG. 2, during a pressure cooking process, a pressure in the cooking cavity can act on the float member 120, and the float member 120 will move along the mounting hole 1101 of the lid body 110 accordingly so that the fitting end 1201 of the float member 120 contacts the lid body 110 and accordingly cuts off an end of the mounting hole 1101, and therefore the cooking cavity is prevented from being in communication with an external environment via the mounting hole 1101 to ensure a stable pressure in the cooking cavity, and the free end 1202 of the float member 120 may protrude from another end of the mounting hole 1101 to prompt a user of a state of pressure in the cooking cavity. As shown in FIG. 3, in the above situation, if the free end 1202 of the float member 120 is subjected to an external force and generates a tendency of movement of retracting into the mounting hole 1101, the float member 120 can use, through a way of compression deformation, its own compression deformation to offset a displacement of the free end 1202. At the same time, based on an arrangement of the limit member 130, a too small distance between the free end 1202 and the fitting end 1201 can also be avoided, and the free end 1202 and the fitting end 1201 can be prevented from contacting with each other due to the compression deformation, thereby preventing a position of the fitting end 1201 from being changed, avoiding the mounting hole 1101 from being turned on during a pressure cooking process, and being conducive to reducing a probability of a high-temperature medium in the cooking cavity released to the outside through the mounting hole 1101 while a stability of an internal pressure of the cooking cavity is ensured, and in turn reducing a risk of scalding user, and therefore improving the safety of the pressure cooking process. Therefore, it is conducive to improving a user experience for the product.

It can be understood that the high-temperature medium may be but is not limited to, a high-temperature gas, a steam, a high-temperature liquid, and so on.

As shown in FIG. 5, in some feasible examples, the pot body assembly 200 may include a first pot body 210 and a second pot body 220. In some embodiments, the first pot body 210 is formed with the pot mouth; the second pot body 220 is formed with a housing groove; and the first pot body 210 is disposed in the housing groove. That is to say, in practical applications, the first pot body 210 and the lid body 110 can enclose a cooking cavity used to accommodate ingredients to be cooked. The second pot body 220 can be used as an outer pot to provide the structural protection for the first pot body 210 and improve aesthetics of the pressure cooking appliance.

In the disclosure, the terms “first,” “second” and “third” are used for descriptive purposes only and shall not be understood as indicating or implying relative importance; the term “a plurality of” refers to two or more than two, unless otherwise expressly limited. The terms “mounting,” “connected to,” “connection” and “fixing” should be understood in a broad sense. For example, “connection” may be a fixed connection, a detachable connection, or an integral connection; “connected to” may be either directly connected or indirectly connected through an intermediary. For those skilled in the art, the specific meanings of the above terms in the disclosure can be understood according to specific circumstances.

In the description of the disclosure, it should be understood that the orientation or positional relationship indicated by the terms “upper,” “lower,” “left,” “right,” “front,” “back” and so on are orientational or positional relationships based on the orientational or positional relationships shown in the accompanying drawings and are only for the convenience of describing the disclosure and simplifying the description, but do not indicate or imply that a device or a unit referred to must have a specific direction, be constructed and operated in a specific orientation, and therefore cannot be understood as a limitation of the disclosure.

In the description of this specification, the terms “an embodiment,” “some embodiments,” “specific embodiments” and so on mean that a specific feature, structure, material, or characteristic described in connection with the embodiment or example is included in at least one embodiment or example of the disclosure. In this specification, schematic representations of the above terms do not necessarily refer to the same embodiment or example. Furthermore, the specific features, structures, materials or characteristics described may be combined in any suitable manner in any one or more embodiments or examples.

The above are only some embodiments of the disclosure and are not intended to limit the disclosure. For those skilled in the art, the disclosure may have various modifications and changes. Any modifications, equivalent substitutions, improvements and so on made within the concept and principles of the disclosure shall be included in the protection scope of the disclosure.

What is claimed is:

1. A pot lid assembly for a pressure cooking appliance comprising:
a lid body including a mounting hole;
a float member, movably penetrating in the mounting hole, and having a fitting end and a free end, the fitting end being configured to turn on or cut off an end of the mounting hole, the free end being arranged close to another end of the mounting hole, and the float member having an extendible structure such that a distance between the free end and the fitting end is adjustable; and
a limit member disposed in the mounting hole configured to limit the distance between the free end and the fitting end;
wherein the fitting end and the free end are located on two sides, respectively, of the limit member along a flow direction of the mounting hole.

2. The pot lid assembly according to claim 1, wherein:
the float member is provided with a positioning member configured to abut against a side of the limit member facing toward the free end; and
in a case that the float member is in an extreme compression state, a distance between the positioning member and the fitting end when the float member is in an extreme compression state is smaller than a minimum distance between the side of the limit member facing toward the free end and the fitting end.

3. The pot lid assembly according to claim 1, wherein:
the float member includes:
a base seat, disposed at the lid body and located at an end of the mounting hole, the base seat including a fitting hole in communication with the mounting hole;
a float body movably penetrating in the fitting hole;
a seal member, sleeved on an end of the float body and configured to cover or open the fitting hole; and
an elastic extendible member, connected to another end of the float body and movably penetrating in the mounting hole; and
the fitting end is formed at the seal member, and the free end is located at an end of the elastic extendible member away from the float body.

4. The pot lid assembly according to claim 3, wherein:
two ends of the elastic extendible member are located on two sides, respectively, of the limit member along the flow direction of the mounting hole, the limit member being configured to limit a distance between the two ends of the elastic extendible member.

5. The pot lid assembly according to claim 3, wherein:
the float member further includes:
a float ejector rod, connected to the elastic extendible member, and formed with the free end; and
a first positioning member, disposed at the float ejector rod and used to abut against the side of the limit member facing toward the free end; and
in a case that the first positioning member abuts against the side of the limit member facing toward the free end, a gap is formed between the float ejector rod and the float body.

6. The pot lid assembly according to claim 5, wherein:
the float member further includes a second positioning member, disposed at the float ejector rod and configured to abut against a side of the limit member facing toward the fitting end, the elastic extendible member being located between the second positioning member and the float body; and
along the flow direction of the mounting hole, a distance between the first positioning member and the second positioning member is greater than a distance between the two sides of the limit member.

7. The pot lid assembly according to claim 5, wherein an end of the float ejector rod close to the float body penetrates in the elastic extendible member.

8. The pot lid assembly according to claim 3, wherein a stiffness coefficient of the elastic extendible member satisfies:
$$k \leq \frac{{p}_{min} \cdot A - {G}_{0} - {G}_{1} - {G}_{2}}{{x}_{max}}$$
where, k is the stiffness coefficient of the elastic extendible member, pₘᵢₙ is a minimum working pressure of the pressure cooking appliance, A is an area of orthographic projection of the seal member on a projection plane perpendicular to the direction of gravity, G₀ is a gravity of the elastic extendible member, G₁ is a gravity of the float body, G₂ is a gravity of the seal member, and xₘₐₓ is a maximum amount of expansion and retraction of the elastic extendible member.

9. The pot lid assembly according to claim 3, wherein:
the elastic extendible member is made of silicone; or
the elastic extendible member includes a spring or an elastic piece.

10. The pot lid assembly according to claim 1, further comprising:
a handle member disposed at the lid body.

11. A pressure cooking appliance comprising:
a pot body assembly formed with a pot mouth; and
a pot lid assembly configured to open or cover the pot mouth, the pot lid assembly including:
a lid body including a mounting hole;
a float member, movably penetrating in the mounting hole, and having a fitting end and a free end, the fitting end being configured to turn on or cut off an end of the mounting hole, the free end being arranged close to another end of the mounting hole, and the float member having an extendible structure such that a distance between the free end and the fitting end is adjustable; and
a limit member disposed in the mounting hole configured to limit the distance between the free end and the fitting end;
wherein the fitting end and the free end are located on two sides, respectively, of the limit member along a flow direction of the mounting hole.

12. The pressure cooking appliance according to claim 11, wherein:
the float member is provided with a positioning member configured to abut against a side of the limit member facing toward the free end; and
in a case that the float member is in an extreme compression state, a distance between the positioning member and the fitting end when the float member is in an extreme compression state is smaller than a minimum distance between the side of the limit member facing toward the free end and the fitting end.

13. The pressure cooking appliance according to claim 11, wherein:
the float member includes:
a base seat, disposed at the lid body and located at an end of the mounting hole, the base seat including a fitting hole in communication with the mounting hole;
a float body movably penetrating in the fitting hole;
a seal member, sleeved on an end of the float body and configured to cover or open the fitting hole; and
an elastic extendible member, connected to another end of the float body and movably penetrating in the mounting hole; and
the fitting end is formed at the seal member, and the free end is located at an end of the elastic extendible member away from the float body.

14. The pressure cooking appliance according to claim 13, wherein:
two ends of the elastic extendible member are located on two sides, respectively, of the limit member along the flow direction of the mounting hole, the limit member being configured to limit a distance between the two ends of the elastic extendible member.

15. The pressure cooking appliance according to claim 13, wherein:
the float member further includes:
a float ejector rod, connected to the elastic extendible member, and formed with the free end; and
a first positioning member, disposed at the float ejector rod and used to abut against the side of the limit member facing toward the free end; and
in a case that the first positioning member abuts against the side of the limit member facing toward the free end, a gap is formed between the float ejector rod and the float body.

16. The pressure cooking appliance according to claim 15, wherein:
the float member further includes a second positioning member, disposed at the float ejector rod and configured to abut against a side of the limit member facing toward the fitting end, the elastic extendible member being located between the second positioning member and the float body; and
along the flow direction of the mounting hole, a distance between the first positioning member and the second positioning member is greater than a distance between the two sides of the limit member.

17. The pressure cooking appliance according to claim 15, wherein an end of the float ejector rod close to the float body penetrates in the elastic extendible member.

18. The pressure cooking appliance according to claim 13, wherein a stiffness coefficient of the elastic extendible member satisfies:
$$k \leq \frac{{p}_{min} \cdot A - {G}_{0} - {G}_{1} - {G}_{2}}{{x}_{max}}$$
where, k is the stiffness coefficient of the elastic extendible member, pₘᵢₙ is a minimum working pressure of the pressure cooking appliance, A is an area of orthographic projection of the seal member on a projection plane perpendicular to the direction of gravity, G₀ is a gravity of the elastic extendible member, G₁ is a gravity of the float body, G₂ is a gravity of the seal member, and xₘₐₓ is a maximum amount of expansion and retraction of the elastic extendible member.

19. The pressure cooking appliance according to claim 13, wherein:
the elastic extendible member is made of silicone; or
the elastic extendible member includes a spring or an elastic piece.

20. The pressure cooking appliance according to claim 11, wherein the pot lid assembly further includes:
a handle member disposed at the lid body.
